(19) United States
(12) Patent Application Publication
(10) Pub. No.: US 2015/0257427 A1
(43) Pub. Date: Sep. 17, 2015

(54) COMPOSITIONS AND METHODS FOR VITAMIN-RICH FERMENTATES

(71) Applicant: THE COCA-COLA COMPANY, Atlanta, GA (US)

(72) Inventors: Jeroen Hugenholtz, Atlanta, GA (US); Thilo Strachotta, Atlanta, GA (US); Maiken Lund Jensen, Espergaerde (DK); Martin Bastian Pedersen, Cadorago Como (IT)

(21) Appl. No.: 14/436,602

(22) PCT Filed: Oct. 17, 2013
(86) PCT No.: PCT/US13/65511

§ 371 Date: Apr. 17, 2015

Related U.S. Application Data
(60) Provisional application No. 61/715,137, filed on Oct. 17, 2012.

(51) Int. Cl. A23L 2/02; A23L 2/60

(52) U.S. Cl. CPC A23L 2/02; A23L 2/60; A23V 2002/00

(57) ABSTRACT

The principles of the present invention provide novel compositions and methods for naturally enriching beverages with multiple vitamins. The method includes fermenting beverages, such as fruit juices, in a single step with a microorganism capable of producing at least four vitamins, such as vitamin B12, vitamin K, folate, and biotin.

### CROSS-REFERENCE TO RELATED APPLICATIONS

This application claims the benefit of U.S. provisional application 61/715,137 filed Oct. 17, 2012, which is incorporated herein by reference in its entirety.

### FIELD OF THE INVENTION

The principles of the present invention relate generally to the field of beverage fermentation. In particular, composition and methods for naturally producing vitamins in beverages, thus improving the nutritional value, are provided by the principles of the present invention.

### BACKGROUND OF THE INVENTION

Vitamins are essential for normal growth and development and for the healthy maintenance of cells, tissues, and organs. Not surprisingly, vitamin deficiency is correlated with numerous physiological disorders. Dietary supplements are often used to ensure adequate amounts of these essential nutrients are obtained on a daily basis. New and improved formulations of beverages are desirable to meet changing market demands. In particular, there is considerable market demand for beverages having naturally-derived alternative nutritional characteristics, such as, for example, increased vitamin content. Therefore, development of new beverage formulations with satisfactory nutritional characteristics and flavor profiles represents an ongoing challenge for the beverage industry.

### BRIEF SUMMARY OF THE INVENTION

In one aspect, the principles of the present invention provide a fermented beverage composition. In one embodiment, the fermented beverage includes increased vitamin B12, vitamin K, folate, and biotin relative to an unfermented equivalent beverage. In yet another embodiment, no exogenous vitamin B12, vitamin K, folate, or biotin is added to the fermented beverage.

In certain embodiments, the fermented beverage includes from about 1-fold, about 2-fold, about 3-fold, about 4-fold, about 5-fold, about 6-fold, about 7-fold, about 8-fold, about 9-fold, about 10-fold, about 15-fold, to about 20-fold the recommended daily intake (RDI) of vitamins B12, vitamin K, folate, and biotin. In some embodiments any combination of the vitamins can be increased by any of the above amounts. At least each of the 4 vitamins is increased a detectable amount when compared to an unfermented counterpart beverage.

In yet another embodiment, the fermented beverage is a fruit juice. In certain embodiments, the fruit juice is at least one juice selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, lime, tangerine, passion fruit, kiwi, persimmon, currant, quince, and guava, or combinations thereof. It should be understood that additional or alternative fruit juices may be included.

In one embodiment, the fermented beverage includes from about 1%, about 2%, about 3%, about 5%, about 10%, about 15%, about 20%, about 25%, about 30%, about 35%, about 40%, about 50%, about 60%, about 65%, about 70%, about 75%, or about 80% by weight fruit juice.

In some embodiments, the fermented beverage is selected from the group consisting of vegetable juice, soy, malt, milk, cereals, coffee, or sugar/water mixtures.

In certain embodiments, the fermented beverage includes a non-nutritive sweetener. In some embodiments, the non-nutritive sweetener includes at least one selected from the group consisting of Stevia rebaudiana extract, stevioside, aspartame, saccharine, and sucralose. In one embodiment the non-nutritive sweetener is rebaudioside A (Reb A). In yet another embodiment, the fermented beverage includes a nutritive sweetener. In some embodiments, the nutritive sweetener includes at least one selected from the group consisting of sucrose, fructose, and glucose. In certain embodiments, the fermented beverage includes an additive selected from the group consisting of salts, food-grade acids, coloring agents, preservatives, ascorbic acid, energy-boosting agents, and vitamins.

In another aspect, the principles of the present invention provide a method of producing a fermented beverage. In one embodiment, the method increases vitamin B12, vitamin K, folate, and biotin relative to an unfermented equivalent beverage. In some embodiments, the method includes fermenting a beverage with a microorganism capable of producing vitamins. In one embodiment, the microorganism produces vitamin B12, vitamin K, folate, and biotin. The method results in a fermented beverage having increased vitamin B12, vitamin K, folate, and biotin when compared to an unfermented equivalent beverage. In yet another embodiment, no exogenous vitamin B 12, vitamin K, folate, and biotin is added.

In certain embodiments, the method includes increasing the vitamin B12, vitamin K, folate, and biotin content from about 1-fold, about 2-fold, about 3-fold, about 4-fold, about 5-fold, about 6-fold, about 7-fold, about 8-fold, about 9-fold, about 10-fold, about 15-fold, to about 20-fold the recommended daily intake (RDI). The vitamins can be increased by similar or different amounts relative to each other. At least each of the 4 vitamins is increased a detectable amount when compared to an unfermented counterpart beverage. In an embodiment, vitamin B12 is increased 1-fold, about 2-fold, about 3-fold, about 4-fold, about 5-fold, about 6-fold, about 7-fold, about 8-fold, about 9-fold, about 10-fold, about 15-fold, to about 20-fold the recommended daily intake (RDI), vitamin K is increased 1-fold, about 2-fold, about 3-fold, about 4-fold, about 5-fold, about 6-fold, about 7-fold, about 8-fold, about 9-fold, about 10-fold, about 15-fold, to about 20-fold the recommended daily intake (RDI), folate is increased 1-fold, about 2-fold, about 3-fold, about 4-fold, about 5-fold, about 6-fold, about 7-fold, about 8-fold, about 9-fold, about 10-fold, about 15-fold, to about 20-fold the recommended daily intake (RDI), and biotin is increased 1-fold, about 2-fold, about 3-fold, about 4-fold, about 5-fold, about 6-fold, about 7-fold, about 8-fold, about 9-fold, about 10-fold, about 15-fold, to about 20-fold the recommended daily intake (RDI), or combinations thereof.

In one embodiment, the method includes the step of fermenting a beverage with a bacterium. In some embodiments, the method includes producing a fermented beverage with a bacterium from the genus Propionibacterium. In yet another embodiment, the method includes producing a fermented beverage with the bacterium Propionibacterium freudenreichii. In one embodiment the disclosure provides a lactic acid bacteria strain selected from the group consisting of the Propionibacterium freudenreichii CHCC15460 strain that was deposited with the Deutsche Sammlung von Mikroorganismen and Zellkulturen under accession no. DSM 26457 and mutants derived thereof.

In particular embodiments, the method includes the step of removing the microorganism from the beverage. In certain embodiments, the method includes the step of removing the microorganism from the beverage after fermentation.

In yet another embodiment, the method includes producing a fermented beverage including a fruit juice. In certain embodiments, the method includes producing a fermented beverage including a fruit juice from at least one of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, line, tangerine, passion fruit, kiwi, persimmon, currant, quince, and guava, or combinations thereof.

In one embodiment, the method includes producing a fermented beverage including from about 1%, about 2%, about 3%, about 5%, about 10%, about 15%, about 20%, about 25%, about 30%, about 35%, about 40%, about 50%, about 60%, about 65%, about 70%, about 75%, or about 80% by weight fruit juice.

In some embodiments, the method includes producing a fermented beverage including at least one of vegetable juice, soy, malt, milk, cereals, coffee, or sugar/water mixtures.

In certain embodiments, the method includes adding a non-nutritive sweetener. In some embodiments, the method includes adding a non-nutritive sweetener selected from the group consisting of Stevia rebaudiana extract, stevioside, aspartame, saccharine, and sucralose. In one embodiment the method includes adding the non-nutritive sweetener rebaudioside A (Reb A). In yet another embodiments of the invention, the method includes adding a nutritive sweetener. In some embodiments, the method includes adding a non-nutritive sweetener selected from the group consisting of sucrose, fructose, and glucose. In certain embodiments, the method includes adding an additive selected from the group consisting of salts, food-grade acids, coloring agents, preservatives, ascorbic acid, energy-boosting agents, and vitamins.

In yet another aspect, the principles of the present invention provide a fermented beverage prepared by the method including the step of increasing vitamin B12, vitamin K, folate, and biotin relative to an unfermented equivalent beverage. In some embodiments, the principles of the present invention provide a fermented beverage prepared by the method including the step of fermenting the beverage with a microorganism capable of producing vitamin B12, vitamin K, folate, and biotin. In particular embodiments, the principles of the present invention provide a fermented beverage prepared by the method including the step of increasing vitamin B12, vitamin K, folate, and biotin content of the beverage without adding exogenous vitamin B12, vitamin K, folate, and biotin.

In an additional aspect, the principles of the present invention provide a raw fermented juice. In one embodiment, the raw fermented juice includes increased vitamin B12, vitamin K, folate, and biotin relative to an unfermented juice equivalent. In yet another embodiment, the raw fermented juice includes a microorganism capable of producing increased vitamin B12, vitamin K, folate, and biotin. In certain embodiments, the raw fermented juice includes at least 1-fold the recommended daily intake (RDI) of vitamin B12, vitamin K, folate, and biotin. In certain embodiments, the raw fermented juice includes no exogenous vitamin B12, vitamin K, folate, and biotin added.

These and other features, aspects, and advantages of the principles of the present invention will become better understood with reference to the following description and claims.

### DETAILED DESCRIPTION OF THE INVENTION

The principles of the present invention are based at least in part on the surprising discovery that fermenting beverages with vitamin-producing microorganisms can naturally, and significantly, increase the concentration of vitamins. As a result, beverages are greatly enriched with vitamins and exhibit little flavor changes and at least partial maintenance of sweetness and mouth feel. Accordingly, the principles of the present invention provide fermented beverage compositions with at least increased vitamin B12, vitamin K, folate, and biotin content as compared to an unfermented equivalent beverage.

As used herein, “fermented beverage” is generally a solution or a dispersion derived from or produced from a solution or dispersion containing a sugar as a substrate to be used by a microorganism. A typical example of such a fermented beverage can be fruit juice. In alternative embodiments, the fermented beverage is selected from grapefruit juice, cherry juice, rhubarb juice, banana juice, passion fruit juice, lychee juice, grape juice, apple juice, orange juice, mango juice, plum juice, prune juice, cranberry juice, pineapple juice, peach juice, pear juice, apricot juice, blueberry juice, raspberry juice, strawberry juice, blackberry juice, huckleberry juice, boysenberry juice, mulberry juice, gooseberry juice, prairie berry juice, elderberry juice, loganberry juice, dewberry juice, pomegranate juice, papaya juice, lemon juice, lime juice, tangerine juice, passion fruit juice, kiwi juice, persimmon juice, currant juice, quince juice, and guava juice, or combinations thereof.

As appreciated by one of skill in the art, water is a basic ingredient in the beverages disclosed here, typically being the primary liquid portion in which the remaining ingredients are dissolved, emulsified, suspended or dispersed. Those of ordinary skill in the art will understand that, for convenience, some ingredients are described herein, in certain cases, by reference to the original form of the ingredient in which it is added to the beverage product formulation. Such original form may differ from the form in which the ingredient is found in the finished beverage product. For example, orange juice is generally made by extraction from the fresh fruit, by desiccation and subsequent reconstitution of dried juice, or by concentration of the juice and the subsequent addition of water to the concentrate. The beverage to be fermented, for instance, can be fresh, can be one containing pulp, or can be one from which pulp has been removed by centrifugation or filtration.

As used herein, a “vitamin” refers to any of a group of organic compounds that are essential for normal growth and nutrition and are required in limited amounts in the diet. The term “vitamin” does not include dietary minerals, essential fatty acids, or essential amino acids. As vitamins are classified by their biological activity and not their structure, each “vitamin” is a generic descriptor and refers to a number of compounds that all show the biological activity associated with a particular vitamin. The generic descriptor “vitamin B12” includes, for example, the compounds cyanocobalamin, hydroxocobalamin, adenosylcobalamin, or methylcobalamin. The generic descriptor “vitamin K” includes 2-methyl-1,4-naphthoquinone derivatives such as, for example, phylloquinone or menaquinones. The generic descriptor “folate” (also known as vitamin B9) includes a large number of folic acid derivatives that differ by their state of oxidation such as, for example, pteroyl-L-glutamic acid, pteroyl-L-glutamate, or pteroylmonoglutamic acid. As used herein, “biotin” (CAS Registry No. 58-85-5; also known as vitamin H, bioepiderm, and coenzyme R) refers to the generic descriptor vitamin B7, and is composed of a tetrahydroimidizalone ring fused with a tetrahydrothiophene ring.

As used herein, “increased vitamins” refers to a beverage having an augmentation in vitamins as compared to the same volume of the standard version, e.g. unfermented version, for instance the starting material prior to fermentation according to the methods. In some embodiments, the fermented beverage includes from about 1-fold, about 2-fold, about 3-fold, about 4-fold, about 5-fold, about 6-fold, about 7-fold, about 8-fold, about 9-fold, about 10-fold, about 15-fold, to about 20-fold the recommended daily intake (RDI) of vitamins. The vitamins can be increased by similar or different amounts relative to each other. At least each of the 4 vitamins is increased a detectable amount when compared to an unfermented counterpart beverage.

In an embodiment, vitamin B12 is increased 1-fold, about 2-fold, about 3-fold, about 4-fold, about 5-fold, about 6-fold, about 7-fold, about 8-fold, about 9-fold, about 10-fold, about 15-fold, or to about 20-fold the recommended daily intake (RDI), vitamin K is increased 1-fold, about 2-fold, about 3-fold, about 4-fold, about 5-fold, about 6-fold, about 7-fold, about 8-fold, about 9-fold, about 10-fold, about 15-fold, or to about 20-fold the recommended daily intake (RDI), folate is increased 1-fold, about 2-fold, about 3-fold, about 4-fold, about 5-fold, about 6-fold, about 7-fold, about 8-fold, about 9-fold, about 10-fold, about 15-fold, or to about 20-fold the recommended daily intake (RDI), and biotin is increased 1-fold, about 2-fold, about 3-fold, about 4-fold, about 5-fold, about 6-fold, about 7-fold, about 8-fold, about 9-fold, about 10-fold, about 15-fold, or to about 20-fold the recommended daily intake (RDI), or combinations thereof.

As used herein, “unfermented equivalent beverage” is a version of a beverage or a beverage that has not undergone the fermentation process in accordance with the principles of the present invention.

As used herein, “recommended daily intake” (RDI) refers to the daily intake level of a nutrient considered sufficient by the Food and Nutrition Board of the National Research Council to meet the requirements of 97-98% of healthy individuals in each life-stage and gender group in the United States.

As used herein, “fermentation” is the breakdown of organic substances by microorganisms to produce simpler organic compounds. While fermentation generally occurs under predominantly anaerobic conditions, it is not intended that the term be limited to strict anaerobic conditions, as fermentation also occurs in the presence of oxygen.

“Exogenous” with reference to a vitamin refers to a vitamin that is added to a composition. A vitamin can be individually, selectively, and/or artificially supplemented to the composition. “Endogenous” with reference to a vitamin refers to a vitamin that occurs naturally in a food or beverage.

As used herein, a “non-nutritive sweetener” is one that does not provide significant caloric content in typical usage amounts, i.e. is one which imparts less than 5 calories per 8 ounce serving of beverage to achieve the sweetness equivalent of 10 Brix of sugar. In various embodiments, the fermented beverage composition further includes a non-nutritive sweetener selected from Stevia rebaudiana extract, stevioside, aspartame, saccharine, and sucralose. In one embodiment the fermented beverage composition includes the non-nutritive sweetener rebaudioside A (Reb A).

As used herein, a “nutritive sweetener” is one that can provide significant caloric content in typical usage amounts, i.e. is one which imparts greater than 5 calories per 8 ounce serving of beverage to achieve the sweetness equivalent of 10 Brix of sugar. In various embodiments, the fermented beverage composition further includes a nutritive sweetener selected from sucrose, fructose, glucose, and high-fructose corn syrup.

As used herein, degrees Brix (° Bx) is the sugar content of an aqueous solution. One degree Brix is 1 gram of sucrose in 100 grams of solution and represents the strength of the solution as percentage by weight (% w/w).

It should be understood that beverages and other beverage products can have any of numerous different specific formulations or constitutions. In general, a beverage typically comprises at least water, acidulant, and flavoring. The beverage products in accordance with the principles of the present invention include beverages, i.e. ready to drink formulations, beverage concentrates, and the like. Juices suitable for use in at least embodiments include, for example, fruit, vegetable, and berry juices. In beverages employing juice, juice may be used, for example, at a level from about 0.2%, about 0.5%, about 1%, about 2%, about 3%, about 5%, about 10%, about 15%, about 20%, about 25%, about 30%, about 35%, about 40%, about 50%, about 60%, about 70%, to about 80% by weight of the beverage.

Accordingly, the principles of the present invention provide a fermented beverage having at least increased vitamin B12, vitamin K, folate, and biotin as compared to an unfermented equivalent beverage. Beverages, of which the taste profiles may be modified by the addition of sweeteners, can be provided. Various beverages, such as fruit juices, contain a limited number of vitamins and thus make it a less preferred choice amongst consumers looking to maintain a healthy diet.

To prepare a fermented beverage composition of the present invention standard fermentation methods can be used. Examples of beverage fermentation can be found in U.S. Pat. No. 4,210,720, U.S. Pat. No. 4,544,633, U.S. Pat. No. 4,867,992; U.S. Pat. No. 7,427,397, U.S. Publication No. 20050180963, U.S. Publication No. 20090269438; EP 0089720, EP 0166238, EP 1625794, EP 1625795, International Publication No. WO2004001022, and International Publication No. WO2012/036575, each of which is expressly incorporated herein by reference. Since propagation of the fermenting microorganism can utilize aerobic conditions, sufficient oxygen can be made available to the microorganisms in the propagation vessel(s). Stirring and/or recirculation may suitably be employed to continuously introduce air or oxygen in the fermenting beverage formulation. Fermenting microorganisms can also be grown under anaerobic conditions whereby oxygen is depleted from the growth environment using known methodologies such as, for example, sparging with nitrogen gas. As such, the principles of the present invention provide a method of producing a fermented beverage comprising incubating a beverage with a microorganism, such as a bacterium, capable of producing vitamins to produce a fermented beverage having at least increased vitamin B12, vitamin K, folate, and biotin as compared to an unfermented equivalent beverage.

At least one microorganism capable of producing vitamins can be used. Enrichment with single vitamins produced by fermentation is known in the art. However, to address the problem of using multiple organisms and multiple fermentation steps, the principles of the present invention make use of vitamin-producing microorganisms for naturally increasing the vitamin content in beverages, of at least four vitamins, by a single fermentation step with a single microorganism.

There are many known vitamin-producing microorganisms that find use in accordance with the principles of the present invention, most of which are bacteria, such as, but not limited to, Propionibacterium, Lactobacillus, and Lactococcus. In one embodiment, the vitamin producing organism is Propionibacterium freudenreichii. In one embodiment the strain is Propionibacterium freudenreichii CH15460 or mutants thereof. The strain was deposited with the Deutsche Sammlung von Mikroorganismen and Zellkulturen under accession no. DSM 26457.

In the present context, the term “mutant” should be understood as a strain derived, or a strain which can be derived from a strain of the invention (or the mother strain) by means of e.g. genetic engineering, radiation and/or chemical treatment. The mutant can also be a spontaneously occurring mutant. It is preferred that the mutant is a functionally equivalent mutant, e.g. a mutant that has substantially the same, or improved properties (e.g., regarding production of vitamins, such as B12, vitamin K, folate and biotin) as the mother strain. Such a mutant is a part of the present invention. Especially, the term “mutant” refers to a spontaneously occurring mutant or to a strain obtained by subjecting a strain of the invention to any conventionally used mutagenization treatment including treatment with a chemical mutagen, such as ethane methane sulphonate (EMS) or N-methyl-N′-nitro-N-nitroguanidine (NTG), or UV light. A mutant may have been subjected to several mutagenization treatments (a single treatment should be understood as one mutagenization step followed by a screening/selection step), but it is presently preferred that no more than 20, or no more than 10, or no more than 5, treatments (or screening/selection steps) are carried out. In a presently preferred mutant less than 1%, less than 0.1%, less than 0.01%, less than 0.001% or even less than 0.0001% of the nucleotides in the bacterial genome have been replaced with another nucleotide, or deleted, compared to the mother strain.

As is conventional in the art, fermentation is achieved when microorganisms, such as, but not limited to, the bacterium P. freudenreichii are added to a medium (e.g., an unfermented beverage such as fruit juice), whereby the microorganisms convert carbon sources to alcohols and other molecules. The production of vitamin B12 and folate in culture, as described herein, have been studied under aerobic conditions as, for example, discussed in Hugenschmidt et al. and Sybesma et al., respectively, which are incorporated herein by reference.

Bacteria capable of producing vitamins typically grow and ferment in a pH range of about 3.0 to 7.0. The fermentation can be allowed to proceed spontaneously, or can be started by inoculation with a culture that has been previously fermented, in which case the unfermented beverage may be inoculated with populations of bacteria as is known in the art and may include, for instance, about 10⁶ to about 10⁷ cfu/ml juice. Incubation can proceed with aeration to facilitate growth of the bacterial population. The temperature of fermentation is usually from 20° C. to 40° C., and the duration of the fermentation process may for example extend from a few hours to greater than 1 or 2 or 3 or 4 or 5 or 6 or 7 or 8 or more days to a few weeks.

Thus, following fermentation, the principles of the present invention provide fermented beverage compositions with increased vitamin content of at least vitamin B12, vitamin K, folate, and biotin, which provides for a nutritionally improved beverage while maintaining sweetness. For example, fruit juices having a vitamin B12, vitamin K, folate, and biotin content of greater than 1-fold the recommended daily intake (RDI) can be provided. In alternative embodiments, principles of the present invention can be used to produce fermented beverages having naturally enriched concentrations of at least vitamin B12, vitamin K, folate, biotin, and in some embodiments 1, 2, 3, 4, 5, 6, 7, 8, 9, or more additional vitamins. In some embodiments, principles of the present invention can be used to provide increased vitamin content in carbonated and non-carbonated soft drinks, fountain beverages, frozen ready-to-drink beverages, coffee beverages, tea beverages, dairy beverages, powdered soft drinks, as well as liquid concentrates, flavored waters, enhanced waters, fruit juice and fruit juice-flavored drinks, sports drinks, and alcoholic products. As appreciated by one of skill in the art, any of these beverages can be the starting material to be fermented according to the methods herein, or are beverages to which fermented beverages can be added.

In one embodiment, the fermented beverage composition is a “raw fermented beverage.” As used herein, “raw” means not processed or purified. Natural embodiments of the beverage products disclosed herein are natural in that they do not contain anything artificial or synthetic. Therefore, as used herein, “natural” beverage composition is defined in accordance with the following guidelines: Raw materials for a natural ingredient exists or originates in nature. Biological synthesis involving fermentation and enzymes can be employed, but synthesis with chemical reagents is not utilized. Artificial colors, preservatives, and flavors are not considered natural ingredients.

Following fermentation one or more post-fermentation processing steps can be used such as pasteurization, filtration, centrifugation, or homogenization. For example, several pasteurization methods are commonly used (see, e.g., U.S. Pat. Nos. 4,830,862 and 4,925,686, incorporated herein by reference). One common method passes juice through a tube next to a plate heat exchanger, so the juice is heated without direct contact with the heating surface. Another method uses hot, pasteurized juice to preheat incoming unpasteurized juice. The preheated juice is further heated with steam or hot water to the pasteurization temperature. Typically, reaching a temperature of 185 to 201.2° F. (85-94° C.) for about 30 seconds is adequate to reduce the microbe count and prepare the juice for filling individual containers. Alternatively, typically at least about 20% of the microorganisms present in the fermented beverage are removed using one or more separators. Examples of separators that may be employed to remove the microorganism-containing residue from the fermented beverage include sedimenters, decanters, centrifuges, hydrocyclones, sieves, filters, membranes and presses. Accordingly, in one embodiment, the method includes a post-processing step of removing the microorganism capable of producing vitamins. In some embodiments, the microorganisms can be removed from the fermentation reaction during fermentation, while in other embodiments, the microorganisms are removed following the completion of fermentation.

Ingredients can be processed or purified through certain specified techniques including at least: physical processes, fermentation, and enzymolysis. Appropriate processes and purification techniques include at least: absorption, adsorption, agglomeration, centrifugation, chopping, cooking (baking, flying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food component, including clarifying agents, catalysts, flocculants, filter aids, and crystallization inhibitors, etc. (see 21 CFR §170.3(o)(24)) are incidental additives and can be used if removed appropriately.

Non-nutritive sweeteners, also called artificial sweeteners, or high-intensity sweeteners, are agents that exhibit a sweetness many times that of sucrose. Examples of high-intensity sweeteners include saccharin, cyclamate, aspartame, monatin, alitame, acesulfame potassium, sucralose, thaumatin, stevioside, glycerrhizin, sucralose, and neotame. Therefore, beverages such as fruit juice, sports drinks, and soft drinks, are sweetened with non-nutritive sweeteners that may not occur naturally in the source ingredients for the beverage and thus are generally regarded as undesirable by many consumers. By contrast, nutritive sweeteners generally refer to naturally occurring substances. Examples of nutritive sweeteners include glucose, fructose, maltose, galactose, maltodextrin, trehalose, fructo-oligosaccharides, and trioses. Due to the prevalence and popularity of non-nutritive sweeteners in beverages, several processes have been described for modifying the taste profile of beverages that contain these non-nutritive sweeteners.

As used herein, “additive” means food additive, or a substance added to food to preserve flavor or enhance its taste and appearance. In some embodiments, the fermented beverage composition further includes an additive selected from salts, food-grade acids, coloring agents, preservatives, ascorbic acid, energy-boosting agents, and vitamins. Further, it will generally be an option to add other ingredients to the formulation of a particular beverage embodiment, including flavorings, electrolytes, tastents, masking agents, flavor enhancers, carbonation, or caffeine.

Once made, the fermented beverage finds use as a beverage of its own or can be mixed with one or more other beverages. Carbon dioxide can be used to provide effervescence to certain embodiments of the beverages disclosed herein. Any of the techniques and carbonating equipment known in the art for carbonating beverages can be employed. Cola beverages, which typically exhibit a dark brown color derived from caramel coloring resulting from heat-treated carbohydrates, can also benefit from the increased vitamin content method in accordance with the principles of the present invention. Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following non-limiting examples are provided to further illustrate the present disclosure. It should be appreciated by those of skill in the art that the techniques disclosed in the examples that follow represent approaches the inventors have found function well in the practice of the present disclosure, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the present disclosure.

### Example 1

Strains

The culture used for the vitamin-enrichment fermentations was Propionibacterium freudenreichii CH15460. This strain was selected from eight other Propionibacterium obtained from the Chr Hansen culture collection. The strain was deposited with the Deutsche Sammlung von Mikroorganismen and Zellkulturen under accession no. DSM 26457. Mutants of the strain also find use in the methods disclosed herein.

Juice Fermentations

Initial fruit juice fermentations were performed by inoculating fruit juice with either 1% or 10% (v/v) of a Propionibacterium freudenreichii culture grown on rich cultivation medium (MRS medium) as is known in the art. This culture was first centrifuged and resuspended in the respective juice to avoid take-over of the rich medium to the juice fermentation. Juice fermentations were incubated at 30° C. for 5-8 days and samples were collected regularly for analysis of vitamins. These samples were heated for 10 min at 80° C. to stop further growth of Propionibacterium and stored at 4° C. before analysis. All fruit juices were commercially available 100% pasteurized juice.

Analysis of Vitamins

Vitamin B12, folate and biotin content was routinely measured using specific microbiological assays by the commercial laboratory of SGS Institut Fresenius in Berlin, Germany. Vitamin K2 content was analyzed by GC-MS.

### Example 2

Vitamin B12 production by fermentation with P. freudenreichii (strains CHCC15460 and strain PA) was assessed in orange juice (Table 1). At 5-8 days post-inoculation with a starter culture of bacteria, fermented orange juice samples were analyzed for vitamin content, pH, and flavor profile. Samples were cultured either aerobically or anaerobically. Aerobic cultures were either sparged with supplemental oxygen or were aerated under ambient conditions by shaking low-volume culture. Anaerobic cultures were either sparged with nitrogen gas or grown in full flasks with no shaking. Post-fermentation samples showed a significant increase in vitamin B12 content with little to no change in flavor and pH. Further, samples grown aerobically did not show significantly increased vitamin production.

### Example 3

Vitamin B12 production by fermentation with P. freudenreichii (strains CHCC15460 and strain PA) was assessed in banana juice (Table 2). At 5-8 days post-inoculation with either a normal (1% v/v) or a heavy (10% v/v) volume of a starter culture of bacteria, fermented banana juice samples were analyzed for vitamin content, pH, and flavor profile. Samples were cultured either aerobically or anaerobically. Aerobic cultures were either sparged with supplemental oxygen or were aerated under ambient conditions by shaking low-volume culture. Anaerobic cultures were either sparged with nitrogen gas or grown in full flasks with no shaking. Strain CHCC15460 produced significantly more vitamin B12 than strain PA and caused little to no change in flavor or pH. Strain CHCC15460 showed a variable response to fermentation with or without oxygen and a 2- to 5-fold increase in vitamin B12 production when a heavy inoculum of starter culture was used for sample fermentation. By contrast, strain PA produced lower amounts of vitamin B12 overall and caused a slight decrease in pH. Further, strain PA showed a significant increase in vitamin B12 production when fermentation samples were cultured aerobically. However, unlike strain CHCC15460, samples fermented with a heavy inoculum of strain PA starter culture showed a undesired change in flavor profile.

### Example 4

Vitamin B12 production by fermentation with P. freudenreichii (strains CHCC15460 and strain PA) was assessed in tomato juice (Table 3). At 5-8 days post-inoculation with a starter culture of bacteria, fermented tomato juice samples were analyzed for vitamin content, pH, and flavor profile. Samples were cultured either aerobically or anaerobically. Aerobic cultures were either sparged with supplemental oxygen or were aerated under ambient conditions by shaking low-volume culture. Anaerobic cultures were either sparged with nitrogen gas or grown in full flasks with no shaking. Strain CHCC15460 produced significantly more vitamin B 12 than strain PA and caused little to no change in flavor and only a slight increase in pH. By contrast, strain PA produced significantly lower amounts of vitamin B12 overall and caused a slight decrease in pH. Further, while strain CHCC15460 produced more vitamin B12 when fermentation samples were cultured with oxygen, strain PA produced less vitamin B 12 under the same conditions. Finally, samples fermented with strain PA developed a sweet, pleasant flavor.

### Example 5

Vitamin production by fermentation with P. freudenreichii (strain CHCC15460) was assessed in various fruit juices (Table 4). At 5-8 days post-inoculation with a starter culture of bacteria, fermented fruit juice samples were analyzed for vitamin content and pH. Duplicate samples of orange, banana, and tomato juice (where indicated) were cultured in a SARTORIUS® fermentor. All samples showed significant levels of vitamin B12, vitamin B6, vitamin K2, and biotin, where calculated. In addition, all samples showed either no change, or a slight increase, in pH.

### Example 6

Vitamin production by fermentation with P. freudenreichii (strain CHCC15460) was assessed in various fruit juices (Table 5). At 5-8 days post-inoculation with a starter culture of bacteria, fermented fruit juice samples were analyzed for vitamin content and pH. All samples showed significant levels of vitamin B12, vitamin K2, and biotin, where calculated. Also, all samples showed slight to moderate changes in pH. Finally, while both mango and orange juice samples showed decreased vitamin content when inoculated with lower volume starter cultures, red beet juice showed decreased vitamin K2 levels when inoculated with a higher volume starter culture.

### Example 7

Vitamin production by fermentation with P. freudenreichii (strain CHCC15460) was assessed in orange juice and mango juice (Table 6). At 3, 5, and 6 days post-inoculation with a starter culture of bacteria, fermented fruit juice samples were analyzed for vitamin content. All samples showed a significant increase in vitamin B12 content after just 3 days post-inoculation. Both juices showed little to no change in vitamin B12 content at later time points. While mango juice samples showed no change in vitamin B6 content after fermentation, significant increases in vitamin K, folate, and biotin were detected. By contrast, orange juice showed no change in vitamin K levels following fermentation.

Deposits and Expert Solution

The strain of Propionibacterium freudenreichii CHCC15460 was deposited with Deutsche Sammlung von Mikrooganismen and Zellkulturen GmbH (DSMZ), Inhoffenstr. 7B, D-38124 Braunschweig, Germany on Oct. 4, 2012 under the accession number DSM 26457.

The deposit has been made under the conditions of the Budapest Treaty on the International Recognition of the Deposit of Microorganisms for the Purposes of Patent Procedure.

The Applicant requests that a sample of the deposited microorganisms should be made available only to an expert approved by the Applicant.

TABLE 1
Vitamin B12 production in orange juice (pH = 3.75) by
Propionibacterium freudenreichii.

| | | Vitamin | | |
|---|---|---|---|---|
| | | B12 | | |
| Sample | Conditions | [μg/L] | pH | Flavor |
| Strain | Normal inoculum − O₂ | 2.4 | 3.89 | Limited change |
| CHCC15460 | Normal inoculum + O₂ | 2.4 | 3.83 | Limited change |
| Strain PA | Normal inoculum − O₂ | 0.7 | 3.85 | Limited change |
| | Normal inoculum + O₂ | 2.5 | 3.83 | Limited change |

TABLE 2
Vitamin B12 production in banana juice (pH = 4.34) by
Propionibacterium freudenreichii.

| | | Vitamin | | |
|---|---|---|---|---|
| | | B12 | | |
| Sample | Conditions | [μg/L] | pH | Flavor |
| Strain | Normal inoculum − O₂ | 19.2 | 4.43 | Limited change |
| CHCC15460 | Normal inoculum + O₂ | 10.2 | 4.29 | Limited change |
| | Heavy inoculum − O₂ | 46.4 | 4.33 | Limited change |
| | Heavy inoculum + O₂ | 50.7 | 4.23 | Limited change |
| Strain PA | Normal inoculum − O₂ | 1.8 | 4.10 | Limited change |
| | Normal inoculum + O₂ | 10.2 | 4.11 | Limited change |
| | Heavy inoculum − O₂ | 2.1 | 4.01 | Banana vinegar |
| | Heavy inoculum + O₂ | 12.1 | 4.02 | Banana vinegar |

TABLE 3
Vitamin B12 production in tomato juice (pH = 4.31) by
Propionibacterium freudenreichii.

| | | Vitamin | | |
|---|---|---|---|---|
| | | B12 | | |
| Sample | Conditions | [μg/L] | pH | Flavor |
| Strain | Normal inoculum − O₂ | 41.0 | 4.49 | Limited change |
| CHCC15460 | Normal inoculum + O₂ | 74.4 | 4.48 | Limited change |
| Strain PA | Normal inoculum − O₂ | 12.1 | 4.19 | Nice sweet |
| | | | | tomato |
| | Normal inoculum + O₂ | 6.49 | 4.18 | Nice sweet |
| | | | | tomato |

TABLE 4
Vitamin production in various fruit juices by Propionibacterium freudenreichii strain CHCC15460.

| Juice | Initial pH | Final pH | Vitamin B12 | Vitamin B6 | Vitamin K2 | Biotin |
|---|---|---|---|---|---|---|
| Tomato | 4.59 | 4.80 | 36 | 340 | 1000 | 100 |
| Orange (2X Sartorius) | 3.61 | 3.90 | 16 | nc | 154 | nc |
| Banana (2X Sartorius) | 4.32 | 4.32 | 21 | nc | 17 | nc |
| Tomato (2X Sartorius) | 4.23 | 4.33 | 7 | nc | 536 | nc |

Values expressed as [μg/L], where nc = not calculated.
Recommended Daily Intake (RDI): vitamin B12 = 2 μg, vitamin B6 = 1 mg, vitamin K2 = 40-80 μg, biotin = 10 μg.

TABLE 5
Vitamin production in various fruit juices by Propionibacterium
freudenreichii strain CHCC15460.

| | | Initial | Final | Vitamin | | |
|---|---|---|---|---|---|---|
| Juice | Inoculum | pH | pH | B12 | Vitamin K2 | Biotin |
| Passion fruit | normal | 3.07 | 3.57 | 2.30 | 99 | 39.5 |
| Strawberry | normal | 3.37 | 4.33 | 59.4 | 55 | 12.7 |
| Malt | normal | 5.56 | 5.22 | 59.4 | 76 | 30.4 |
| Mango | normal | 3.21 | 3.85 | 99.0 | 310 | 115.0 |
| | low | 3.21 | 3.38 | nc | 46 | nc |
| Orange | normal | 3.76 | 4.23 | 62.5 | 302 | 28.1 |
| | low | 3.76 | 3.96 | nc | 167 | nc |
| Red Beet | normal | 4.81 | 4.59 | 74.3 | 152 | 40.0 |
| | low | 4.81 | 4.57 | nc | 307 | nc |

Values expressed as [μg/L], where nc = not calculated.
Recommended Daily Intake (RDI): vitamin B12 = 2 μg, vitamin K2 = 40-80 μg, biotin = 10 μg.

TABLE 6
Vitamin production in orange juice and mango juice by Propionibacterium freudenreichii
strain CHCC15460.

| Sample | Time point | Vitamin B12 | Vitamin B6 | Vitamin K | Folate | Biotin |
|---|---|---|---|---|---|---|
| Orange 1 | Pre-inoculation | 0.00 | 910.0 | 103 | 284 | 10.20 |
| | 3 d post-inoculation | 14.00 | nc | nc | nc | 12.80 |
| | 5 d post-inoculation | 15.80 | nc | nc | nc | 15.30 |
| | 6 d post-inoculation | 17.30 | nc | nc | nc | 14.50 |
| Orange 2 | Pre-inoculation | 0.00 | nc | 101 | nc | 10.20 |
| | 3 d post-inoculation | nc | nc | nc | nc | nc |
| | 5 d post-inoculation | nc | nc | nc | nc | nc |
| | 6 d post-inoculation | 7.33 | nc | 120 | nc | 10.10 |
| Mango 1 | Pre-inoculation | 0.00 | 280 | 150 | 292 | 4.79 |
| | 3 d post-inoculation | 12.60 | nc | nc | nc | 8.96 |
| | 5 d post-inoculation | 13.50 | nc | nc | nc | 8.33 |
| | 6 d post-inoculation | 11.30 | 260 | 436 | 815 | 8.75 |
| Mango 2 | Pre-inoculation | 0.00 | nc | 150 | nc | 4.79 |
| | 3 d post-inoculation | nc | nc | nc | nc | nc |
| | 5 d post-inoculation | nc | nc | nc | nc | nc |
| | 6 d post-inoculation | 6.52 | nc | 354 | nc | 6.88 |

Values expressed as [μg/L], where nc = not calculated.

### REFERENCES

The following references, to the extent that they provide exemplary procedural or other details supplementary to those set forth herein, are specifically incorporated herein by reference.
U.S. Patent Publication No. 2005/0180963
U.S. Patent Publication No. 2009/0269438
U.S. Pat. No. 4,210,720
U.S. Pat. No. 4,544,633
U.S. Pat. No. 4,830,862
U.S. Pat. No. 4,925,686
U.S. Pat. No. 6,492,141
U.S. Pat. No. 7,371,547
U.S. Pat. No. 7,427,397
U.S. Pat. No. 7,670,814
U.S. Pat. No. 7,718,407
U.S. Pat. No. 7,981,657
European Patent EP0087920
European Patent EP0668359
European Patent EP1625794
European Patent EP1625795
World IP Organization Publication WO2004/001022
Hugenschmidt et al., Process Biochemistry, 46:1063-1070, 2011.
Santos et al., Appl. Environ. Microbiol., 74(10):3291-3294, 2008.
Sybesma et al., Metabolic Engineering, 6:109-115, 2004.

1. A fermented beverage composition comprising increased vitamin B12, vitamin K, folate, and biotin relative to an unfermented equivalent beverage, wherein no exogenous vitamin B12, vitamin K, folate, or biotin are added.

2. The composition of claim 1, wherein the fermented beverage comprises from about 1-fold to about 20-fold the recommended daily intake of vitamins B12, vitamin K, folate, and biotin.

3. The composition of claim 1, wherein the fermented beverage is a fruit juice.

4. The composition of claim 3, wherein the fruit juice is juice from a fruit selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, line, tangerine, passion fruit, kiwi, persimmon, currant, quince, and guava, or combinations thereof.

5. The composition of claim 1, wherein the fermented beverage comprises from about 1% to about 80% by weight fruit juice.

6. The composition of claim 1, wherein the fermented beverage is selected from the group consisting of vegetable juice, soy, malt, milk, cereals, coffee, or sugar/water mixtures.

7. The composition of claim 1, comprising a non-nutritive sweetener.

8. The composition of claim 7, wherein the non-nutritive sweetener is selected from the group consisting of Stevia rebaudiana extract, stevioside, aspartame, saccharine, and sucralose.

9. The composition of claim 1, comprising a nutritive sweetener.

10. The composition of claim 9, wherein the nutritive sweetener is selected from the group consisting of sucrose, fructose, and glucose.

11. The composition of claim 1, comprising an additive selected from the group consisting of salts, food-grade acids, coloring agents, preservatives, ascorbic acid, energy-boosting agents, and vitamins.

12. A method of producing a fermented beverage comprising increased vitamin B12, vitamin K, folate, and biotin relative to an unfermented equivalent beverage, comprising fermenting the beverage with a microorganism capable of producing vitamin B12, vitamin K, folate, and biotin, wherein no exogenous vitamin B12, vitamin K, folate, or biotin are added.

13. The method of claim 12, wherein the fermented beverage comprises from about 1-fold to about 20-fold the recommended daily intake of vitamins B12, vitamin K, folate, and biotin.

14. The method of claim 12, wherein the microorganism is a bacterium.

15. The method of claim 14, wherein said bacterium is from the genus Propionibacterium.

16. The method of claim 15, wherein said bacterium is Propionibacterium freudenreichii.

17. The method of claim 12, further comprising the step of removing the microorganism from the beverage.

18. The method of claim 12, wherein the fermented beverage is a fruit juice.

19. The method of claim 18, wherein the fruit juice is a juice from a fruit selected from the group consisting of grapefruit, cherry, rhubarb, banana, passion fruit, lychee, grape, apple, orange, mango, plum, prune, cranberry, pineapple, peach, pear, apricot, blueberry, raspberry, strawberry, blackberry, huckleberry, boysenberry, mulberry, gooseberry, prairie berry, elderberry, loganberry, dewberry, pomegranate, papaya, lemon, line, tangerine, passion fruit, kiwi, persimmon, currant, quince, and guava, or combinations thereof.

20. The method of claim 12, wherein the fermented beverage comprises from about 1% to about 80% by weight fruit juice.

21. The method of claim 12, wherein the fermented beverage is selected from the group consisting of vegetable juice, soy, malt, milk, cereals, coffee, or sugar/water mixtures.

22. The method of claim 12, comprising the step of adding a non-nutritive sweetener.

23. The method of claim 22, wherein the non-nutritive sweetener is selected from the group consisting of Stevia rebaudiana extract, stevioside, aspartame, saccharine, and sucralose.

24. The method of claim 12, comprising the step of adding a nutritive sweetener.

25. The method of claim 24, wherein the nutritive sweetener is selected from the group consisting of sucrose, fructose, and glucose.

26. The method of claim 12, further comprising the step of adding an additive selected from the group consisting of salts, food-grade acids, coloring agents, preservatives, ascorbic acid, energy-boosting agents, and vitamins.

27. A composition prepared by the method of claim 12.

28. A raw fermented juice comprising increased vitamin B12, vitamin K, folate, and biotin relative to a unfermented juice equivalent, wherein said fermented juice further comprises a microorganism capable of producing vitamin B12, vitamin K, folate, and biotin.

29. The raw fermented juice of claim 28, comprising increased vitamin B12, vitamin K, folate, and biotin at least 1-fold the recommended daily intake, wherein no exogenous vitamin B12, vitamin K, folate, or biotin are added.

30. The method of claim 16, wherein said bacterium is selected from the group consisting of the Propionibacterium freudenreichii CHCC15460 strain that was deposited with the Deutsche Sammlung von Mikroorganismen und Zellkulturen under accession no. DSM 26457 and mutants derived thereof.

31. A lactic acid bacteria strain selected from the group consisting of the Propionibacterium freudenreichii CHCC15460 strain that was deposited with the Deutsche Sammlung von Mikroorganismen und Zellkulturen under accession no. DSM 26457 and mutants derived thereof.
